(19) United States
(12) Patent Application Publication
(10) Pub. No.: US 2023/0342700 A1
(43) Pub. Date: Oct. 26, 2023

(54) Data Supply Chain Governance

(71) Applicant: Jeffrey B Perkins, San Rafael, CA (US)

(72) Inventor: Jeffrey B Perkins, San Rafael, CA (US)

(21) Appl. No.: 17/725,927

(22) Filed: Apr. 21, 2022

(51) Int. Cl. G06Q 10/08; G06Q 30/00

(52) U.S. Cl. CPC G06Q 10/08; G06Q 30/018; G06Q 2220/18

(57) ABSTRACT

The present disclosure is directed to the application of data governance within the domain of a data supply chain, under the jurisdiction of a governing authority. Governance is specified and administered through the mechanism of a data contract, which binds a data supplier to perform a data service on a data object per a specification for a data consumer. Contractual incentives enforce compliance. The data supply chain is the collection of all data contracts operating within the domain identified by the governing authority. The governing authority may monitor the health of the data supply chain, and take actions to improve the health of the data supply chain.

### CROSS-REFERENCE TO RELATED APPLICATIONS

Not Applicable

### BACKGROUND OF THE INVENTION

Data is important to many functions in the world. But how does a data consumer know if the data is good?

In an ideal world, a data consumer gets exactly the data service they need, when they need it, how they need it, from a data supplier who is fully knowledgeable, committed, and happy to deliver in adherence to specifications. However, this is not often the case.

Many data consumers have concerns. Many consumers: do not know where the data comes from; do not know who supplies the data; do not know if the suppliers act in an accountable manner; do not know if the data is fit for the purpose; do not know if the data meets the specifications; do not know if the data is designed properly; do not know if the data has been handled with integrity throughout its lifecycle or lineage; do not trust the quality of the data; do not know regulatory requirements for the data; are unsure of the security and resiliency of the data; do not feel empowered to get the data services they need; do not feel assurance that they will continue to get the data they need over the course of time; and are frustrated with the lack of consistency and completeness in methods of working with data suppliers.

Many data suppliers have concerns. Many suppliers: do not know where the data goes; do not know who consumes the data; do not know if the consumers act in an accountable manner; do not trust that the data is being used for its intended or proper purpose; do not know the specifications that the data should meet; do not know the design that the data should meet; do not know what handling, care, security, resiliency, retention, and services should be applied to the data; do not know timing and method of delivery requirements for the data; do not know regulatory requirements for the data; do not feel incented for their work with the data; do not feel empowered in their relations with data consumers; and are frustrated with the lack of consistency and completeness in methods of working with data consumers.

The risk is large. Given the preponderance of data, the pervasiveness of data as a key factor in many of the world’s functions, and the velocity of the data enabled world, failures in data promulgated by any of these concerns can have significant consequences, from a very small scale that may affect a single individual, to a very large scale that may affect the entire world.

Individually, a consumer or a supplier may address some of these concerns in a satisfactory manner. Some known methods or systems of data governance may offer fragmented or partial solutions to some of these concerns. But due to the nature of data being obtained from many sources, used by many entities, existing in many forms, spanning many technologies, changing in many ways, integrating across many functions, and rapidly growing in importance and scale throughout the world, such individual or fragmented approaches are challenged to achieve broad success, potentially leaving many gaps unfilled. Many efforts to implement data governance have failed, for many reasons, including failing to: define roles; consider dependencies; employ best practices; provide documentation and training; plan and budget for essential components, resources, and timelines; execute decisions and configurations correctly; integrate methods and systems; and other reasons.

There remains a need for a data governance method, a data governance system, and a method for implementing the data governance method and the data governance system into an integrated data governance environment, that is simple in concept, comprehensive in scope, consistent in application, highly scalable, highly configurable, focused and lean, directly deployable by, empowering of, collaborative for, and enforceable amongst, the affected entities, that addresses the aforementioned individual and collective concerns of the consumers and of the suppliers.

### BRIEF SUMMARY OF THE INVENTION

Example approaches for instantiating accountability, incentive, and enforcement among direct participants exist in several venues outside of data governance. A fair analogy for the present disclosure may be a free market economy, wherein, via mutual agreement, consumers incent suppliers to deliver the goods and services that they want. A contract may be used to bind the agreement, and provide specifications and enforcement. Each party is engaged of their own free will. Each is rewarded in terms satisfactory to themselves: the supplier gets paid, and the consumer gets their desired goods and services. If there is disagreement, a governing authority may adjudicate the contract.

This summary is provided to introduce a selection of concepts in a simplified form that are further described below in the Detailed Description. This summary is not intended to identify key features or essential features of the claimed subject matter. Nor is this summary intended to be used to limit the claimed subject matter’s scope.

Consistent with embodiments of the present disclosure, a data supply chain governance environment may be provided comprised of a data supply chain governance method and a data supply chain governance system. Furthermore, a method for implementing a data supply chain governance method and a data supply chain governance system integrated into a data supply chain governance environment may be provided.

The embodiments may include data supply chain governance methods comprising: defining a purpose; defining a data object whose consumption is required to attain the purpose; defining a data service required to support the object; defining a specification to which the data service must adhere; identifying the consumer of the data object; identifying a supplier of the data service; implementing a contract that binds the supplier to perform the service on the object per the specification for the consumer; identifying a governing authority with jurisdiction to adjudicate a contract dispute; identifying a data supply chain, which contains one or more contracts, and which is contained within the jurisdiction of the governing authority; collecting a metric, and then calculating a score or a statistic, on the performance of the service, the attainment of the purpose, or the health of the data supply chain; defining a threshold for the metric, the score, or the statistic; enumerating and invoking an incentive, triggered by the threshold, to enforce the contract with the supplier or the consumer; and enumerating and invoking an action, triggered by the threshold, for improving the health of the data supply chain by the governing authority.

The embodiments may include a data supply chain governance system to facilitate the execution of a data supply chain governance method.

The embodiments may include a method to implement a data supply chain governance environment, comprised of a data supply chain governance method and a data supply chain governance system.

As elucidated below in the Detailed Description, and as represented herein by several best mode examples, such a data governance environment would be: simple in concept, in that the use of a data contract as an enforceable agreement between supplier and consumer is an easily understood parallel to standard business contracts; comprehensive in scope, in that every type of data object, service, and entity is covered; consistent in application, in that the singular contractual method is applied to all data objects, services, and entities; highly scalable, in that it can apply in a very small scale as a single contract for a single service for a single object for a single supplier and a single consumer, all the way to a very large scale as many contracts for many services for many objects for many entities across an entire enterprise or even larger; highly configurable, in that all attributes of the objects, services, specifications, metrics, incentives, and actions are selectable, and the technical environment is agnostic; focused and lean, in that consumers and suppliers can choose to include only what is of value to them in the contracts; directly deployable by affected entities, in that consumers and suppliers may enter contracts of their own volition, without the need of outside help; directly empowering of affected entities, in that consumers and suppliers may be the instigators, and are the decisionmakers, of the contracts; directly collaborative for affected entities, in that the contract is, by its nature, mutually agreeable, and thus encourages consumers and suppliers to collaborate to optimize the benefit for both parties; and directly enforceable amongst the affected entities, in that the contractual incentives induce compliance of the suppliers and consumers, with disputes adjudicated by the governing authority. Thus, the present disclosure provides all of the mechanism and agency necessary for consumers and suppliers to address their aforementioned individual and collective concerns.

While seemingly simple in concept, the novel combination of components of the present disclosure provides a seamlessly integrated unique invention which has proven non-obvious to current practitioners.

### BRIEF DESCRIPTION OF THE DRAWINGS

The accompanying drawings, which are incorporated in and constitute a part of this disclosure, illustrate various embodiments of the present disclosure. The drawings may contain reference numbers, wherein like reference numbers in the present disclosure identify corresponding text. The drawings may contain text or captions that may explain certain embodiments of the present disclosure, wherein this text is included for illustrative, non-limiting, explanatory purposes of certain embodiments detailed in the present disclosure. In the drawings:

FIG. 1 illustrates an embodiment of a data contract;

FIG. 2 illustrates an embodiment of a data object hierarchy;

FIG. 3 illustrates an embodiment of a data supply chain, with a collection of example data contracts;

FIG. 4 illustrates an embodiment of metric, statistic, and score relationships;

FIG. 5 illustrates an embodiment of metric, statistic, and score values;

FIG. 6 illustrates an embodiment of thresholds, incentives and actions;

FIG. 7 illustrates an embodiment of a data supply chain governance system, with examples of presentation modes;

FIG. 8 illustrates an embodiment of a data model, as understood from the contract perspective; and

FIG. 9 illustrates an embodiment of an implementation method for a data supply chain governance environment.

### DETAILED DESCRIPTION OF THE INVENTION

The invention of the present disclosure is described with specificity herein to meet statutory requirements. Although the following text sets forth a detailed description of numerous different embodiments, it should be understood that the legal scope of the description is defined by the claims set forth at the end of this disclosure. The detailed description is to be construed as exemplary only and does not describe every possible embodiment. Numerous alternative embodiments could be implemented, which would still fall within the scope of the claims.

The detailed description contains headers. It should be understood that these headers are used as references and are not to be construed as limiting upon the subject matter disclosed under the header.

### 1. Definitions

There is no intent to limit the meaning of any term used in the present disclosure, either expressly or implicitly, beyond its plain and ordinary meaning, with the exception of the following terms, which are defined as: data, which is defined information that is consumed to attain a purpose; purpose, which is a defined and measurable outcome of an activity; object, which is a governable unit of data; service, which is a defined activity performed on an object; specification, which is a defined requirement for a service; consumer, which is an entity that consumes data, wherein an accountable consumer has the authority to bind to a contract; supplier, which is an entity that performs a service, wherein an accountable supplier has the authority to bind to a contract; contract, which is an enforceable agreement binding a supplier to perform a service on an object per a specification for a consumer; data supply chain, which is a domain which may contain a collection of one or more contracts under the jurisdiction of a governing authority; governing authority, which is an entity with authority to adjudicate contract disputes between suppliers and consumers within a data supply chain, and with the accountability to maintain the health of the data supply chain; metric, which is data measuring the performance of a service, the attainment of a purpose, or the health of a data supply chain; statistic, which is a calculated combination comprising one or more metrics and/or one or more scores, for use in evaluating the performance of a service, the attainment of a purpose, or the health of a data supply chain; score, which is a calculated combination comprising a metric or a statistic, that factors a result to the scaling and weighting preferences of the governing authority, for use in evaluating the performance of a service, the attainment of a purpose, or the health of a data supply chain; threshold, which is a defined point along the scale of a metric, a score, or a statistic; incentive, which is an inducement prescribed in a contract, triggered when a threshold is exceeded, intended to incent the desired performance of an activity by a supplier or a consumer; and action, which is an activity by the governing authority, triggered when a threshold is exceeded, intended to improve the health of the data supply chain.

### 2. Overview

Consistent with embodiments of the present disclosure, a data supply chain governance environment may be provided comprised of a data supply chain governance method and a data supply chain governance system. Furthermore, a method for implementing a data supply chain governance method and a data supply chain governance system integrated into a data supply chain governance environment may be provided. The present disclosure provides the mechanism and agency necessary for consumers and suppliers to address their aforementioned individual and collective concerns, thereby enabling a data consumer to get the data service they need, when they need it, how they need it, from a data supplier who is fully knowledgeable, committed, and happy to deliver in adherence to specifications.

### 3. Governance Method

Consistent with embodiments of the present disclosure, a method of data supply chain governance is provided.

### 3a. Contract

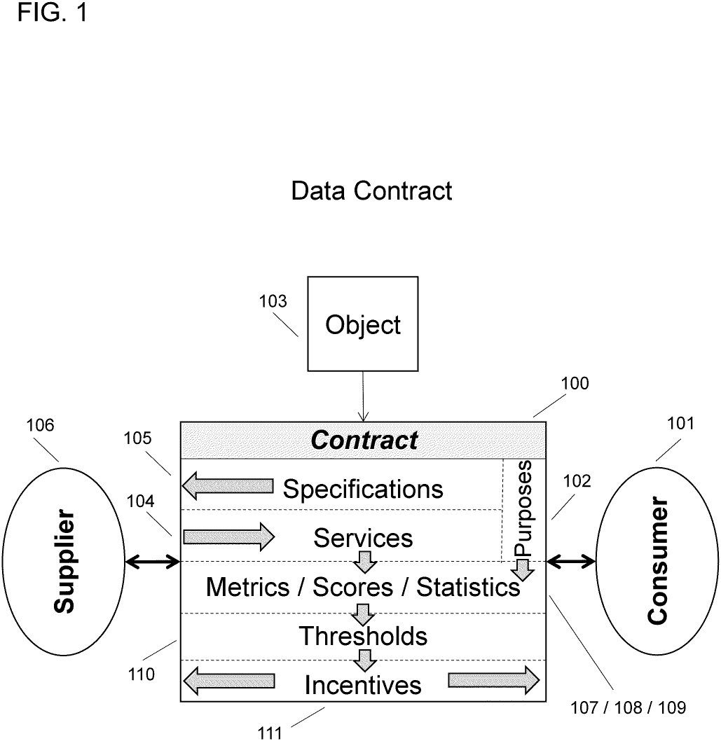

A key component of the present disclosure is a contract. FIG. 1 illustrates an example contract 100.

Within such a contract 100, a consumer 101: may define a purpose 102 to be attained; may define an object 103 necessary for the attainment of the purpose 102; may identify a service 104 necessary to be performed upon the object 103; and may define a specification 105 to which the performance of the service 104 must adhere. A supplier 106 and the consumer 101 may agree to the contract 100 which binds the supplier 106 to perform the service 104 on the object 103 in adherence with the specification 105. The contract 100 may define a metric 107 which may measure the performance of the service 104 to the specification 105. The contract 100 may define a metric 107 which may measure the attainment of the purpose 102. The contract 100 may define a statistic 109 which may be calculated as a combination of a metric 107 and/or a score 108. The contract 100 may define a score 108 which may be calculated as a combination including a metric 107 or a statistic 109. The contract 100 may define a threshold 110 associated with the metric 107 or the score 108 or the statistic 109. The contract 100 may define an incentive 111 for the supplier 106 or for the consumer 101, to be invoked when the threshold 110 is exceeded.

The supplier 106 and the consumer 101 may be any type of entity. They may be an individual, or a group of individuals, or a department, or a company, or a government, or an association such as industry or professional or philanthropic, or any other type of entity. The supplier 106 and the consumer 101 may be different types of entities. The accountable individuals of each entity may have the authority to bind to the contract.

The contract 100 may take many forms. It may be a formal legal agreement which is signed, notarized, recorded, and upholdable in a court of law. It may be a digital transaction recording the specifics of the contractual attributes, relationships, and agreements. It may be a handshake agreement between close and familiar associates. Or it may be any other form that fulfills the contract functions described herein.

The object 103 may take many forms. The object’s 103 representation may be physical or virtual. The object’s 103 scale may be anywhere from very small to very large. Some examples of objects 103 may include: a single field, such as the zip code within an address within a customer table; a logical grouping of fields, such as an address, comprised of street, city, state, country, and zip code fields within a customer table; a single table, such as a customer table within a sales force automation application database; a logical grouping of records, such as a bill of material structure, comprised of product, component, and relationship records joined by a unique key; an entire application database, such as from an enterprise resource planning system; an entire physical data center; a cryptographic hash within a block within a blockchain ledger distributed across the internet; a complete cloud computing environment; or any other form of an object 103.

If the consumption of the object 103 is automated in whole or in part, the consumer 101 may be the administrator of the automation mechanism.

The service 104 may take many forms. The service 104 may affect the data content of the object 103. The service 104 may affect the environment of the object 103. The service 104 may affect operational uses of the object 103. The service 104 may affect the implementation of the object 103 and/or its environment. The service 104 may be performed manually, or by automation, or by any combination thereof. The service 104 may be directed toward many aspects of the object 103, including: design, structure, content, accuracy, integrity, security, storage, access, presentation, retention, resilience, volume, throughput, timeliness, or any other aspect of the object 103. Some examples of services 104 may include: the manual maintenance of data by a department which enters, edits, and deletes data content per requests; the execution of an application that synthesizes real time input from multiple factory machines into a control variable for an automated factory control system; the issuance of error reports by an audit system when data values do not match predefined data quality rules; the creation of new data structures for a new application by a software developer; the recording by hand of the quantitative results of experiments in a laboratory notebook by a scientist; the provision of data security in a commercial cloud by a hacker intrusion system; the granting of access authorization to new users by a network administrator; the backup of live data content, and the archival retention of historical data, by a 3^{rd} party data vault company to an offsite location; the broadcasting of data to multiple audiences through multiple social media outlets by a public relations firm; the hosting of secure virtual private network transmissions of data to distributed corporate locations by an internet provider; or any other form of a service 104 performed on an object 103.

If the service 104 is automated in whole or in part, the supplier 106 may be the developer of the automation mechanism if the service 104 is for the implementation of the automation mechanism, or the supplier 106 may be the administrator of the automation mechanism if the service 104 is for the operation of the automation mechanism.

The specification 105 may take many forms. The specification may contain a single provision, or may contain multiple provisions. The provisions may be independent, or may be interdependent, or may be any combination thereof. The provisions may be individually measurable, or may be collectively measurable, or may be any combination thereof. A provision may be for the result of the service 104 performed. A provision may be for the manner in which the service 104 is performed. A provision may be quantitative or qualitative. A provision may be objective or subjective. A quantitative provision may be to a single value, or to multiple values, or to a range of values, or to a calculated value or values, or to value limits, or to any other representation of value. A provision may be variable. A provision may be conditional. Some examples of provisions of specifications 105 may include: a state field must contain a proper postal state abbreviation of one of the 50 United States; a price field must be 20% or more than the value of the cost of goods sold field; if today is Wednesday, the dinner special field value must be meat loaf; the size of the profit field must allow for 9 significant digits; the credit card application must accept 10,000 transactions per hour; the financial records database must be retained for 15 years; the number of hacker penetrations of the nuclear weapons control network must be 0 per month; there must be 0 liquor sale transactions in blue law states on Sunday; or any other form of a provision within a specification 105 for a service 104 performed.

The purpose 102 may take many forms. The purpose 102 may be quantitative or qualitative. The purpose 102 may be objective or subjective. If quantitative, the purpose 102 may be to a single value, or to multiple values, or to a range of values, or to a calculated value or values, or to value limits, or to any other representation of value. The purpose 102 may be variable. The purpose 102 may be conditional. Some examples of purposes 102 may include: profitability; sales growth; regulatory compliance; product quality; customer satisfaction; inventory efficiency; low cost; agile operation; employee retention; balanced budget; green environmental impact; world hunger eradication; or any other form of a purpose 102.

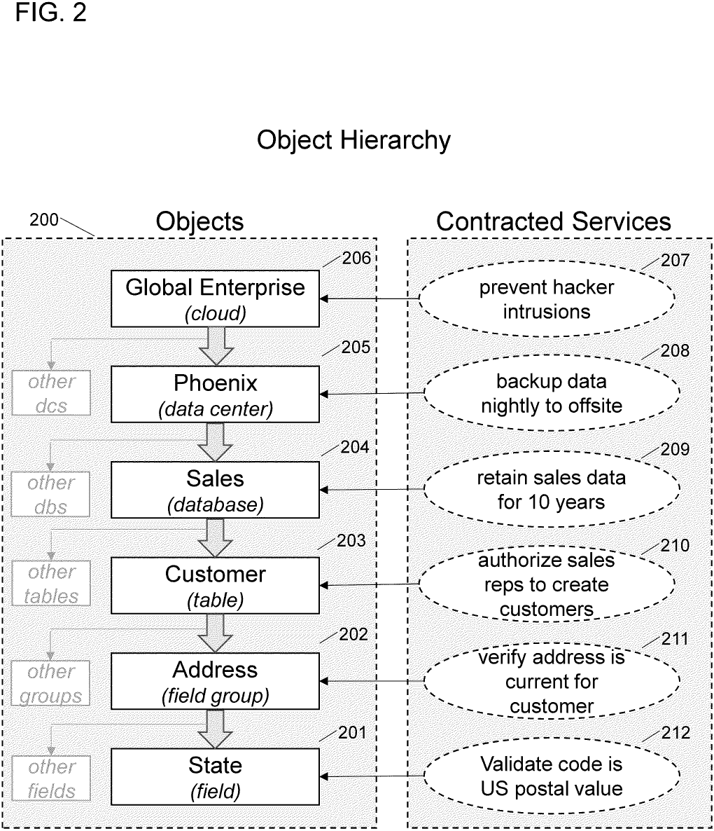

An object may relate to another object, in a hierarchical manner. FIG. 2 illustrates an example of an object hierarchy 200. In such a hierarchy, a subordinate object implicitly inherits all contractual attributes of a superior object. This allows a contract to be applied at the most appropriate level of the object hierarchy, enhancing efficiency and effectiveness of the contract. For example, a field object 201 may be part of a field group object 202, which may be part of a table object 203, which may be part of a database object 204, which may be part of a data center object 205, which may be part of a cloud object 206. For this example: a hacker security service 207 may be contracted for the cloud object 206, which then implicitly applies to all subordinate field, group, table, database, and data center objects within the cloud; a data backup service 208 may be contracted for the data center object 205, which then implicitly applies to all subordinate field, group, table, and database objects within the data center; a data retention service 209 may be contracted for the database object 204, which then implicitly applies to all subordinate field, group, and table objects within the database; a user permissions service 210 may be contracted for the table object 203, which then implicitly applies to all subordinate field and group objects within the table; a content verification service 211 may be contracted for the field group object 202, which then implicitly applies to all subordinate fields within the field group; and a content validation service 212 may be contracted for the field 201, which is the lowest level object, and therefore is not inherited by any other objects.

### 3b. Data Supply Chain

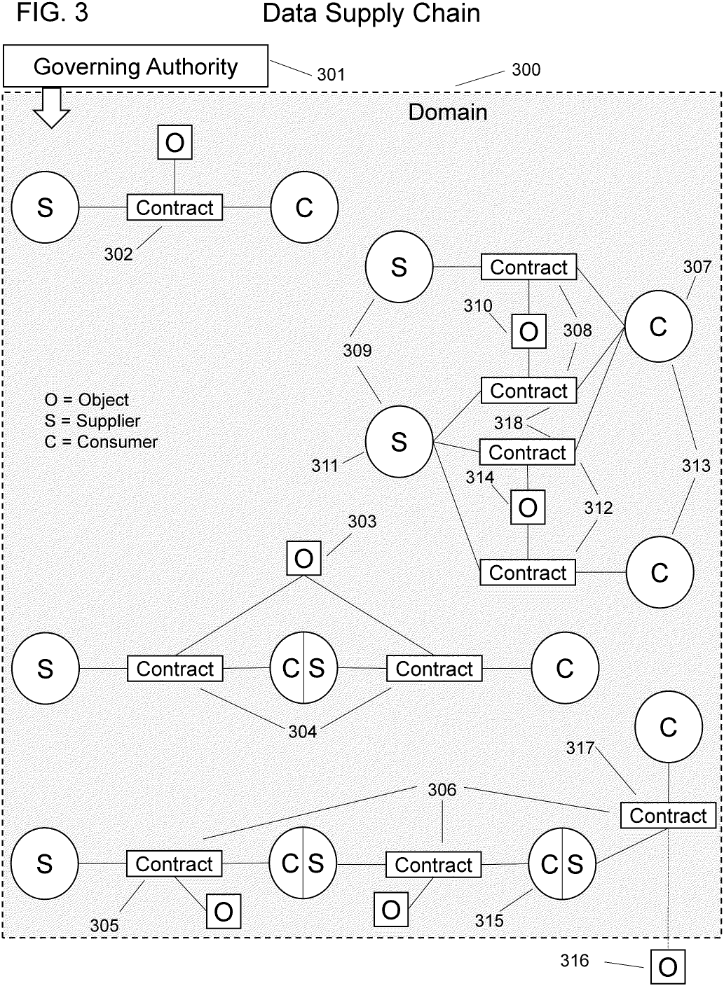

A key component of the present disclosure is a data supply chain. FIG. 3 illustrates an example data supply chain 300.

A governing authority 301 may define the domain of a data supply chain 300. The data supply chain may contain one or more contracts. The governing authority 301 may have jurisdiction over all contracts that fall within the domain of the data supply chain 300.

The relation of the contracts in the data supply chain 300, and the relationship of the components of the contracts, may take many forms. Some examples of relationships may include: a contract 302 may have only one object, one consumer, and one supplier; an object 303 may be referenced in multiple contracts; a string of contracts 304 may perform a series of services upon a single object involving a string of suppliers and consumers; a string of contracts 306 may perform a series of services upon a series of objects involving a string of suppliers and consumers, wherein the objects may be affected individually, or the objects may have cumulative effects from the performance of the series of services; a consumer 307 may have multiple contracts 308 with multiple suppliers 309 that affect a single object 310; a supplier 311 may have multiple contracts 312 with multiple consumers 313 that affect a single object 314; a supplier 311 may have multiple contracts 318 for multiple objects with a single consumer 307; a supplier 315 may also be a consumer 315; a contract 302 may be unrelated to another contract 305, or may be unrelated to another string of contracts 304; or any other form of relationship among contracts, and/or relationship of the components of the contracts, within a data supply chain 300.

An object 316 may be instantiated external to the data supply chain 300. A service performed on the external object 316 under a contract 317 by a supplier 315 that falls within the domain of the data supply chain may be considered within the jurisdiction of the governing authority 301.

New contracts may be added to a data supply chain. If a consumer and a supplier enter into a new contract, and it falls within the domain of the data supply chain, then the new contract is considered a part of the data supply chain.

Existing contracts may be removed from a data supply chain. If a consumer and a supplier terminate an existing contract, and it fell within the domain of the data supply chain, then the terminated contract is considered removed from the data supply chain.

A data supply chain may coexist with other data supply chains. The data supply chains may be independent, or may be contiguous, or may be overlapping to some degree, or may be hierarchical, or may be related in some other manner. In the event of any overlap, the affected governing authorities may work collaboratively to resolve any conflict of jurisdiction.

### 3c. Metrics, Statistics, and Scores

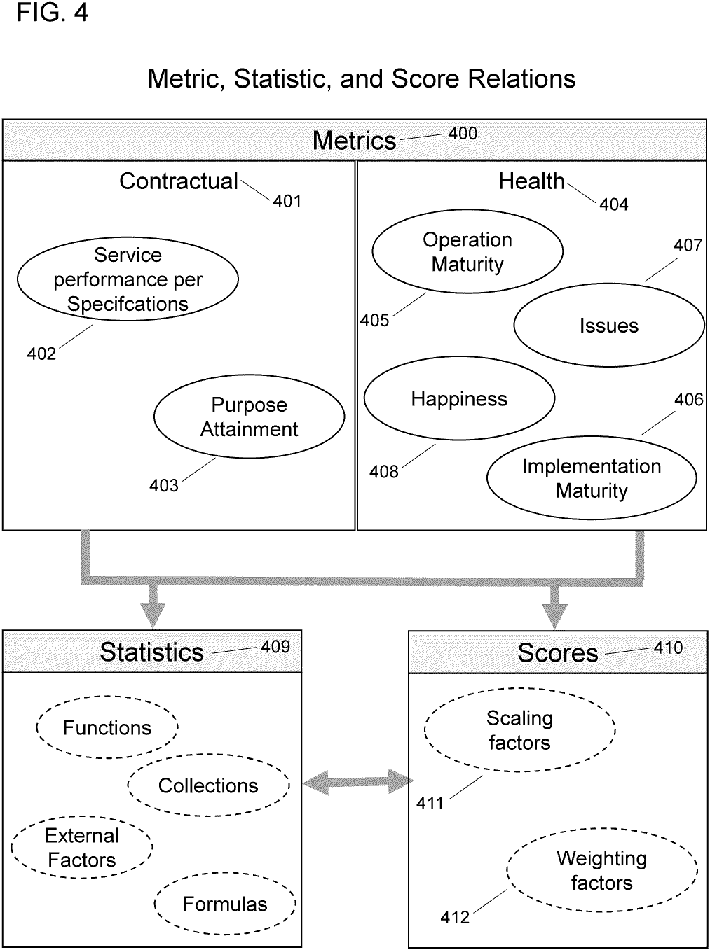

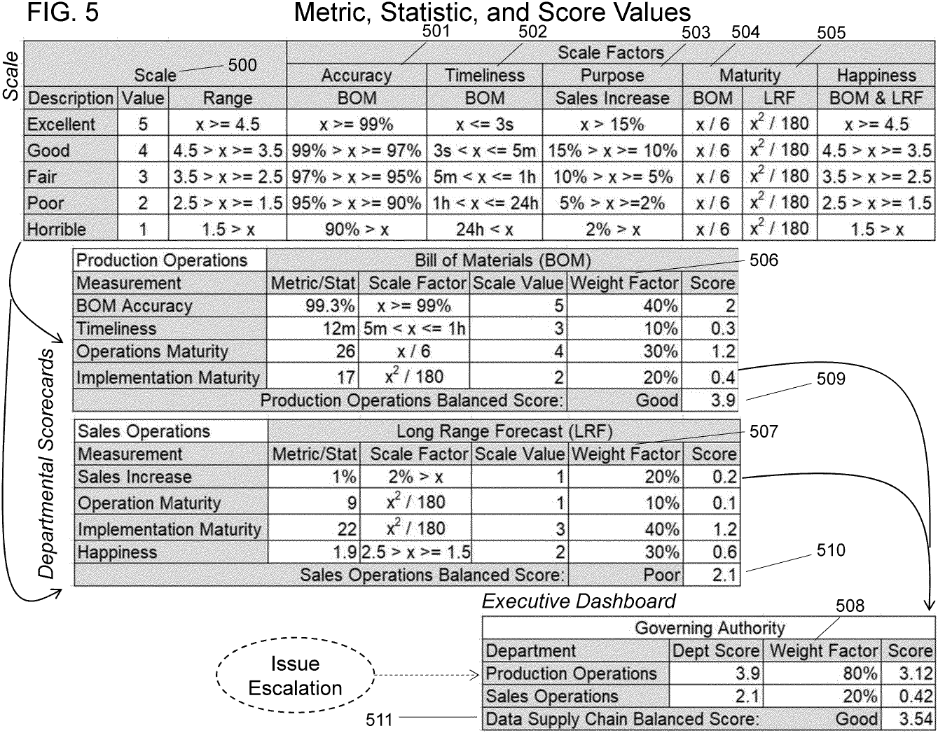

Key components of the present disclosure are metrics, statistics, and scores. Metrics may be collected. Statistics and/or scores may be calculated. FIG. 4 illustrates example relationships and components of metrics, statistics, and scores. FIG. 5 illustrates example values of metrics, statistics, and scores.

A metric 400 may be specific to, and defined within, a contract 401.

Such a contractual metric 401 may measure the performance of a service 402. Such a metric 402 may be associated to a specification. Some examples of such metrics 402 may include: a measurement of whether or not the quantity field value in a bill of material component record matches the engineering drawing; a measurement of how long it takes for a data entry department to enter a new bill of material dataset; a measurement of whether a state field contains a proper postal state abbreviation of one of the 50 United States; a measurement of the difference of a price field value from the cost of goods sold field value; a measurement of the size of the profit field; a measurement of the number of credit card application transactions processed; a measurement of the number of years that a financial records database has been retained; a measurement of the number of hacker penetrations of the nuclear weapons control network; a measurement of the number of liquor sale transactions executed in a state on Sunday; or any other form of a metric for a service performed.

Such a contractual metric 401 may measure the attainment of a purpose 403. Some examples of such metrics 403 may include: a measurement of the profit margin of a product line; a measurement of sales volume for a division; a measurement of the number penalties received during compliance audits from a regulatory agency; a measurement of the number of defective products produced; a measurement of responses from post sales customer satisfaction surveys; a measurement of inventory turnover in a distribution center; a measurement of cost of goods sold for a production line; a measurement of the number of green certifications received across all corporate facilities worldwide; or any other form of a metric for a purpose attained.

A metric may measure the health of a data supply chain 404. The health metric 404 may be unassociated with a contract or contracts within the data supply chain. The health metric 404 may span a portion of, or the entirety of, the data supply chain.

Such a health metric 404 may measure an aspect of operation maturity of a data supply chain 405. Such a metric 405 may be used to assess the current operational health of the data supply chain. Some examples of such metrics 405 may include: a measurement of consumers that lack an object; a measurement of objects that lack a specification; a measurement of specifications that lack a purpose; a measurement of objects that lack a service; a measurement of services that lack a supplier; a measurement of objects and services that lack a contract; a measurement of specifications and purposes that lack a metric; a measurement of metrics, statistics, and scores that lack a threshold; a measurement of incentives that lack a threshold; or any other form of a metric for operation maturity.

Such a health metric 404 may measure an aspect of implementation maturity of a data supply chain 406. Rather than measuring the current operational health directly, such a metric 406 may measure the impact of a change being implemented into the operational environment of the data supply chain. Such a metric 406 may be used to assess the anticipated future health of the data supply chain after a change is implemented. Examples of such metrics 406 may be the same as for the operation maturity metrics 405, but are measured at the point of implementation, rather than the point of operation.

Such a health metric 404 may measure issues in the data supply chain 407. Such a metric 407 may be collected among entities within the data supply chain.

Such a health metric 404 may measure the happiness of individuals participating within the data supply chain 408. Some individuals may have emotional perspectives that are not aligned with other measurements of the data supply chain. Therefore, a measurement of an individual’s happiness with the data supply chain 408 may provide valuable insights to the true, or the perceived, health of the data supply chain. Some examples of such metrics 408 may include: a measurement of happiness with the scope of the data; a measurement of happiness with the impact of the data; a measurement of happiness with the design of the data; a measurement of happiness with the quality of the data; a measurement of happiness with the accountability of the data; a measurement of happiness with the performance of services for the data; a measurement of happiness with the incentives for the performance of services; a measurement of happiness with the effort and cost to maintain the data; or any other form of a metric for happiness.

A statistic 409 may be a calculated combination comprising metrics 400 and/or scores 410. The statistic 409 may be across any collection of one or more components of the data supply chain. The calculation may use any mathematical function or formula. The combination may be of one or several metrics 400, one or several scores 410, one or several external factors, or any combination thereof. The statistic 409 may be defined within a contract, or independent of contracts. Some examples of such statistics 409 may include: a bill of material accuracy statistic that considers a single BOM accurate if the metrics for all key fields across the BOM’s product, component, and relationship records are good, and then calculates the percentage of BOMs that are accurate among all active BOMs at the manufacturing site; a BOM timeliness statistic that calculates an average of all of the collected metrics for the time required to enter a new bill of material dataset during a month; a sales increase purpose statistic that sums up all of the sales volume metrics for all products for a year, and calculates the percentage of increase from the same summation from the previous year; a data integrity statistic that combines scores calculated from collected metrics of data security, data resiliency, data retention, data authorization, data quality, and data provenance, proportioned to a best practices data operations benchmark scale published by an industry association; an implementation maturity statistic that factors the sum of each of 6 collected implementation maturity metrics to a 5-point scale, and then sums the 6 factored products together, and then squares the product to conform to an exponential scale; or any other form of a statistic 409.

A score 410 may be a calculated combination comprising a metric 400 or a statistic 409. The score 410 may be across any collection of one or more components of the data supply chain. The calculation may use any mathematical function or formula. The combination may include a scaling factor 411, for the use of normalizing scores across the collection to the preferences of the governing authority. The combination may include a weighting factor 412, for the use of balancing scores across the collection to the preferences of the governing authority. The score may be defined within a contract, or may be independent of contracts.

Some examples of such scaling factors may include: a 5-point scale 500 ranging from horrible to excellent; a bill of material accuracy scale 501 which requires a very tight tolerance due to its product being regulated, and hence may vary from < 90% as horrible to > 99% as excellent; a bill of materials timeliness scale 502 which reflects expected long manual data entry times for horrible through good scale points, but sets an aspirational 5 second target for excellence; a sales increase purpose scale 503 which intends to drive data service performance improvement through contractual association to this key business metric; a bill of materials maturity scale 504 which may use a linear calculation formula to reflect a stable operating environment with change predictability anticipated; and a long-range forecast maturity scale 505 which may use an exponential calculation formula to inspire rapid improvement in a chaotic operating environment with change disruption anticipated.

Some examples of such weighting factors may include: production operations, which as a stable mature group with regulated output, uses weighting factors 506 that emphasize predictable high-quality manufacturing with BOM accuracy weighted above all other factors; sales operations, which as a newly formed group with chaotic performance, uses weighting factors 507 that emphasize building competency with implementation maturity weighted above all other factors; and the governing authority, which uses weighting factors 508 that recognize the current importance of good production operations in a regulated environment, and also grants some leeway to the newly formed sales operations group to mature before raising expectations.

Some examples of such scores may include: the production operations departmental scorecard shows a calculated good score 509 as a result of the combination of metrics, statistics, scaling factors, and weighting factors; the sales operations departmental scorecard shows a calculated poor score 510 as a result of the combination of metrics, statistics, scaling factors, and weighting factors; and the executive dashboard shows a calculated good score 511, but just barely above the range limit of > 3.5, indicating a potential concern if sales operations do not improve.

### 3d. Thresholds, Incentives, and Actions

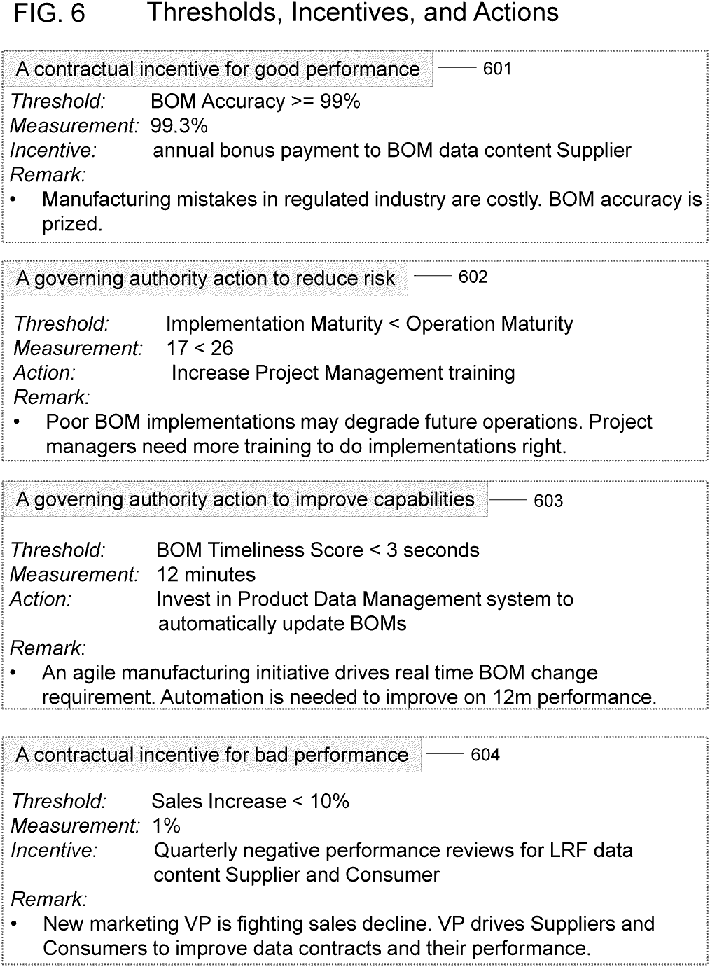

Key components of the present disclosure are incentives and actions, which may be triggered when thresholds are exceeded. FIG. 6 illustrates examples of thresholds, incentives, and actions.

A threshold may take many forms. A threshold may be ascribed to a metric, a statistic, or a score. A threshold may be defined within, and applicable within, a contract. Or a threshold may be unassociated, in part or in whole, with a contract. A threshold may be static or variable. A threshold may be conditional. A threshold may be considered exceeded as either an upper limit or as a lower limit along the specified scale.

An incentive may take many forms. An incentive may be defined within, and applicable within, a contract. An incentive may be invoked when a specified threshold is exceeded. An incentive may be awarded to a supplier or to a consumer. An incentive may be positive, such as a reward, or an incentive may be negative, such as a punishment. An incentive may have a physical manifestation, such as a bonus payment or a gift; or an incentive may have a virtual manifestation, such as a compliment or a promotion. An incentive may be variable. An incentive may be conditional. An incentive may be invoked for an individual, or an incentive may be invoked for a group, such as a team, a department, or a company.

An action may take many forms. An action may be unassociated with a contract. An action may be invoked when a specified threshold is exceeded. An action may be assigned to a governing authority. An action may be prescribed, with specific activities and results expected; or an action may be discretional, with the governing authority deciding on activities and results in response to circumstances. An action may be variable. An action may be conditional.

Some examples of thresholds, incentives, and actions may include: per a contract agreement, an annual bonus payment reward incentive 601 is invoked to a bill of material data content supplier when the bill of material accuracy statistic threshold of 99% is exceeded; per a contract agreement, a quarterly negative comment punishment incentive 604 is invoked in the performance reviews of the long-range forecast data content supplier and consumer when the sales increase purpose statistic lower limit threshold of 10% is exceeded; an action by the governing authority to increase project management training funding 602 is invoked when the bill of material implementation maturity health statistic is less than the BOM operation maturity health statistic, which is an indicator that operation maturity may be at risk of declining; and an action by the governing authority to invest in a product data management automation system 603 is invoked when the bill of material timeliness statistic proves historically that the current manual data entry technique will never come close to the threshold of < 3 seconds mandated by agile manufacturing targets.

### 4. Governance System

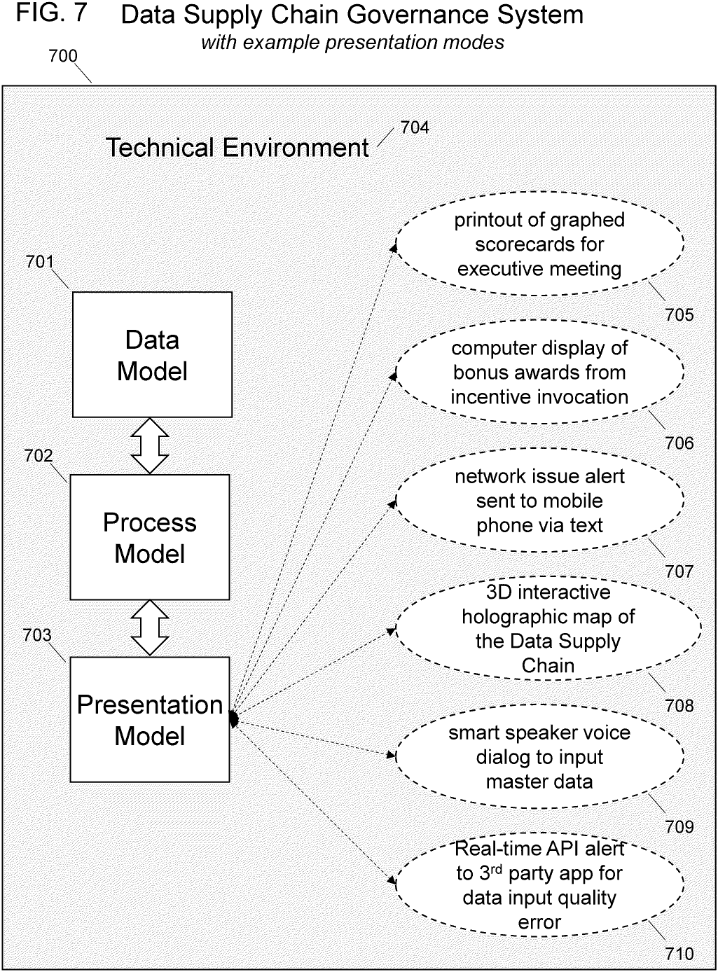

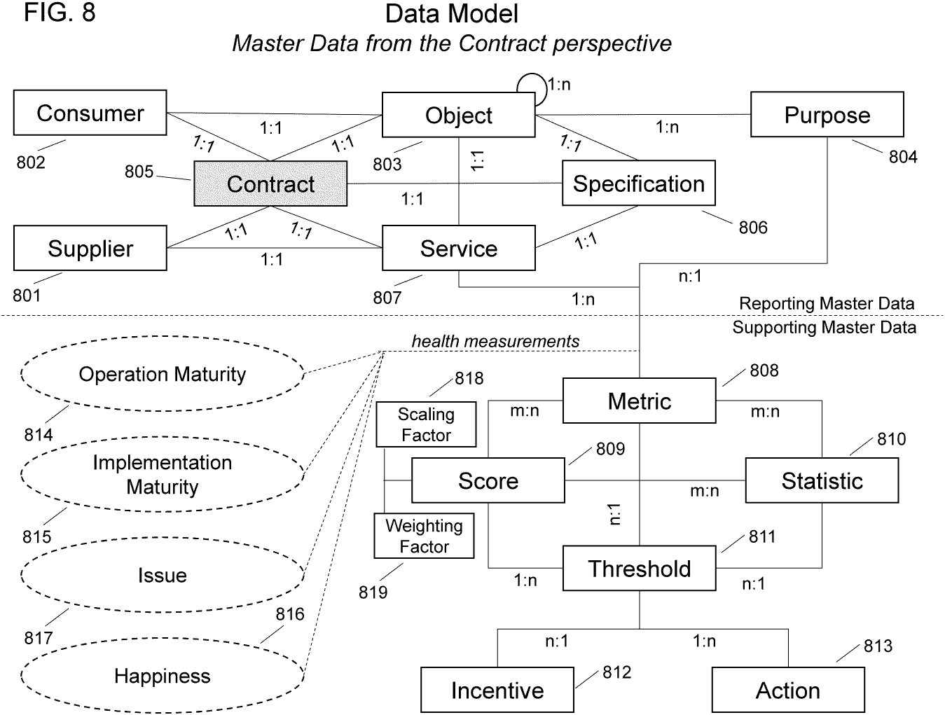

Consistent with embodiments of the present disclosure, a system may facilitate the execution of a data supply chain governance method. FIG. 7 illustrates an example system 700. FIG. 8 illustrates an example data model 800, showing some of the key entities representing the data supply chain, and the relationships between those entities, using a contract as a perspective.

A system 700 may be comprised of a data model 701, a process model 702, and a presentation model 703. Said models may be hosted in a technical environment 704, which may provide all hardware, software, media, and/or other technical items required for the instantiation of, and the execution of, said models.

The system 700 may be technologically agnostic. The technical environment 704 may take many forms. The technical environment 704 may be configured to facilitate the execution of a data supply chain governance method. The technical environment 704 may contain an integration, in whole or in part, of commercially available applications for data governance, data quality metrics, relational data management, and/or other commercially available applications. The technical environment 704 may contain an integration, in whole or in part, of custom written software. The technical environment 704 may be deployed on a large scale using commercially available cloud and/or wide area network services. The technical environment 704 may be deployed on a small scale using a single personal computer and employing the data, processing, and presentation capabilities of a commercially available spreadsheet application. The technical environment 704 may use no computers at all, and instead rely on data recorded in green paper ledger books and processing performed with an abacus and key sort punch cards. The technical environment 704 may use an as yet to be invented algae based biologic artificial intelligence neural network. The technical environment 704 may be any combination of the above, or may take any other form capable of hosting the data, process, and presentation models.

The data model 701 may contain data entities that represent a data supply chain governance method. The data model 701 may contain reporting master data entities such as: supplier 801, consumer 802, object 803, purpose 804, contract 805, specification 806, service 807, and/or other reporting master data entities. The data model 701 may contain supporting master data entities such as: metric definition 808, score definition 809, statistic definition 810, threshold 811, scaling factor 818, weighting factor 819, incentive definition 812, action definition 813, operation maturity definition 814, implementation maturity definition 815, issue definition 816, happiness definition 817, and/or other supporting master data entities. The data model 701 may contain transaction data entities such as: collected metrics, collected issues, calculated scores, calculated statistics, incentive invocation history, action invocation history, intermediate results required for process execution, and/or other transaction data entities. The data model 701 may contain relations between the data entities such as: purpose to object, object to object, consumer to object, object to service, object to specification, specification to service, supplier to service, contract to consumer, contract to supplier, contract to object, contract to service, contract to specification, service to metric, purpose to metric, metric to statistic, metric to score, score to statistic, scaling factor to score, weighting factor to score, metric to threshold, statistic to threshold, score to threshold, threshold to incentive, threshold to action, and any other relations between the data entities. The data model 701 may contain additional entities, and/or additional relations between entities, necessary to support the functions of the process model 702 and the presentation model 703.

The process model 702 may contain activities to be performed to facilitate the execution of a data supply chain governance method. The process model 702 may contain activities such as: maintaining the master data; collecting the issues; collecting the metrics; calculating the scores and the statistics; generating the presentations and managing the presentation dialogues; managing the incentive invocations and the action invocations; and/or any additional activities necessary to support the data model 701 and the presentation model 703. An activity of the process model 702 may be initiated on a scheduled basis, an event driven basis, or an ad hoc basis. An activity of the process model 702 may be triggered and executed by an automated mechanism, or a manual mechanism, or any combination thereof.

The presentation model 703 may present content and accept input to facilitate the execution of a data supply chain governance method. The presentation model 703 may interact with a user via a user interface device such as a display, a printer, a speaker, or any other type of user interface device. The presentation model 703 may interact with another system via a technical communication device such as an application programming interface, or any other type of technical communication device. The presentation model 703 may present content through a device, and in a format, that is configurable to the preferences of a user, or configurable to the requirements of another system, within the constraints of the technical environment 704 capabilities. The presentation model 703 may present content that is filtered by selectable parameters such as: any collection of one or more of the reporting master data entity attributes; any timeframe, such as a current or an historical point in time, or an historical time period; and/or any other selectable parameters.

A presentation may take many forms. The presentation model 703 may present the metrics, the scores, and/or the statistics, with the option of highlights at the thresholds, with the option of summarization at any level of the reporting master data entity attributes, such as an executive scorecard graphic printout 705. The presentation model 703 may present the invocations of the incentives and/or the actions, such as a bonus awards display 706. The presentation model 703 may present alerts when the thresholds are exceeded, such as text alerts warning of an impending network failure to network administrators 707. The presentation model 703 may present a map of the data supply chain, with options to select which entities, which attributes, and which relations to present, through an interactive 3D holographic virtual reality map 708 presented in a holodome. The presentation model 703 may present user interaction interfaces for all activities in the processing model for which user interaction is required, such as a computer-to-human voice dialogue for customer master data input through a smart speaker 709. The presentation model 703 may present external system interaction interfaces for all activities in the processing model for which external system interaction is required, such as a computer-to-computer interaction for a real time data quality check of the state code field value in a 3^{rd} party sales force automation system through an application programming interface 710. Or the presentation may take any other form within the constraints of the data model 701, the process model 702, and the technical environment 704.

### 5. Implementation Method

Consistent with embodiments of the present disclosure, a method of implementing a data supply chain governance environment is provided. Said environment may be comprised of a data supply chain governance method and a data supply chain governance system. The implementation may be for a new data supply chain governance environment, or the implementation may be for a change to an existing data supply chain governance environment.

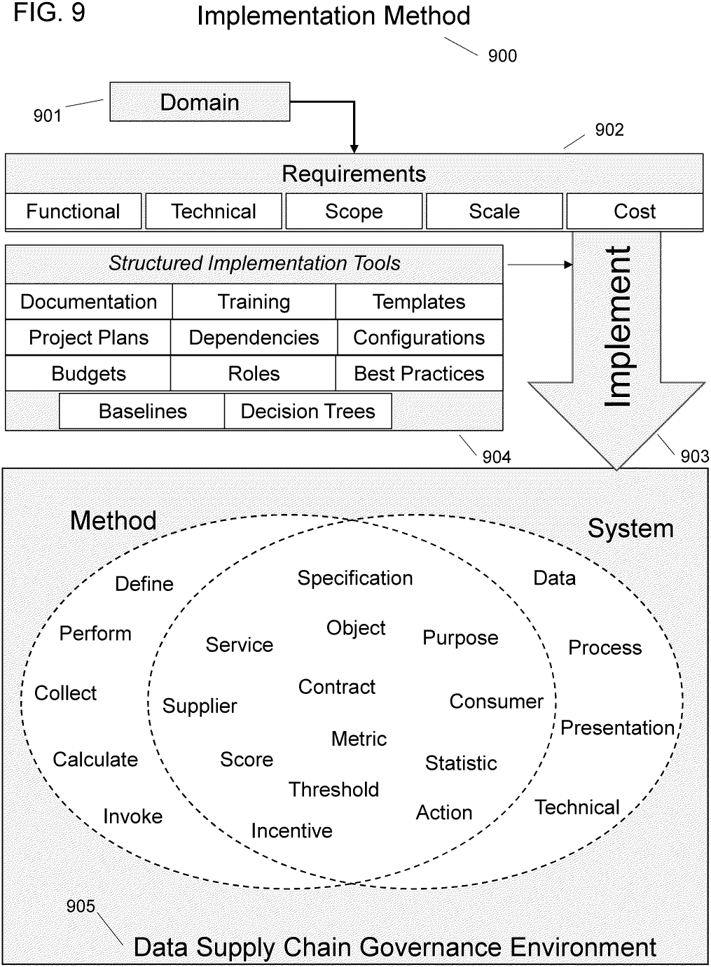

FIG. 9 illustrates an example implementation method 900. The domain 901 of the data supply chain may be identified. The requirements 902 for the data supply chain governance environment may be specified. The implement task 903 may be performed, which may be facilitated by means of structured implementation tools 904.

The requirements 902 may take many forms. The requirements 902 may align with the design and intent of a data supply chain governance environment 905 as described in the present disclosure. The requirements 902 may impose limitations as bounded by realities of the situation. Some example requirement types may include: functional, technical, scale, scope, budget, or any other type of requirement 902.

The implement task 903 may take many forms. The implement task 903 may comply with the requirements 902. The implement task 903 may implement a new or changed data supply chain governance method, or may implement a new or changed data supply chain governance system in facilitation of a data supply chain governance method, or any combination thereof. The implement task 903 may be very small, such as to implement a single change to a single specification in a single contract in an existing data supply chain governance environment 905. The implement task 903 may be very large, such as to implement a new data supply chain governance environment 905 across a global enterprise. The implement task 903 may execute in a manner that preserves the integrity and functionality of the data supply chain governance environment 905. The implement task 903 may execute in a manner that preserves the ability to implement future changes to the data supply chain governance environment 905.

The structured implementation tools 904 may take many forms. Said tools 904 may be designed specifically for a data supply chain governance environment 905 implementation. Said tools 904 may guide the implementors to the best choices, best steps, best configurations, and best practices to facilitate the implement task 903. Said tools 904 may provide implementors with predetermined deliverables to reduce the workload of the implement task 903. Said tools 904 may provide implementors with structure and knowledge which reduces the risk and the uncertainty of the implement task 903, while enhancing the consistency, the competency, the efficiency, and the efficacy of the implement task 903. Said tools 904 may be designed for use as is, or may be designed as a starting point or a guide, from which further customization makes them useful for a particular implementation. Some examples of such tools 904 may include: documentation, wherein predetermined informative content applicable to a data supply chain governance environment and/or its implementation is structured and published, such as a manual of how a supplier and a consumer should interact through a contract; training, wherein predetermined training content for actions performed to implement or operate a data supply chain governance environment is published, such as training for a governing authority to adjudicate a contract dispute; templates, wherein predetermined content shells for components of a data supply chain governance environment are preformatted and published, such as an array of contract and specification templates for use with various different service and object types; project plans, wherein predetermined common steps, sequences, critical paths, and other project plan elements necessary for implementing a data supply chain governance environment are prepopulated into standard project plan tools, such as a prefilled Gantt chart to guide the population of the entities of a data model; configurations, wherein predetermined software settings and/or hardware assemblies necessary for a data supply chain governance environment are prepared, such as an auto-install wizard that sets configuration switches for a commercially available software application; dependency charts, wherein predetermined component and/or technical item relationships required for a successful data supply chain governance environment are charted, such as warnings of method integrity compromises if certain data model entities are not populated; budgets, wherein predetermined budget line items and financial calculations for hardware, software, and human resources required during a typical data supply chain governance environment implementation are populated, such as a spreadsheet with budget line items with variable quantity fields that automatically scale the budget based on choices made in the project plan; role definitions, wherein a list of accountabilities, responsibilities, and expected actions for each role defined in a data supply chain governance environment are published, such as for a supplier, a consumer, or a governing authority; best practices, wherein predetermined real world examples of practices that are known to work well in specific data supply chain governance environment instances are published, such as a recommended type of incentive to include in a contract, depending on whether a supplier is internal or external to an organization; baselines, wherein typical or minimal lists of components, items, and activities required for a data supply chain governance environment implementation are published, such as a list of minimal specifications that may be useful for each service type; decision trees, wherein predetermined options and criteria for known decision points in a data supply chain environment implementation are published, such as decision criteria to help select the most efficient level of an object hierarchy at which to implement a contract; or any other type of structured implementation tool 904 designed specifically for a data supply chain governance environment 905 implementation.

### 6. Notices

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

1. A method of data supply chain governance, comprising: defining a purpose; defining a data object whose consumption is required to attain the purpose; defining a data service required to support the object; defining a specification to which the data service must adhere; identifying the consumer of the data object; identifying a supplier of the data service; implementing a contract that binds the supplier to perform the service on the object per the specification for the consumer; identifying a governing authority with jurisdiction to adjudicate a contract dispute; enforcing the contract; identifying a data supply chain, which contains one or more contracts, and which is contained within the jurisdiction of the governing authority; and improving the health of the data supply chain.

2. The method of claim 1, wherein metrics are defined and collected comprising: measuring the adherence of the service performance to the specification; measuring the attainment of the purpose; measuring the operational maturity of the data supply chain and its components; measuring the contract implementation for its impact on the operational maturity of the data supply chain and its components; measuring issues encountered by the consumer and/or by the supplier with the data supply chain and its components; and measuring the happiness of the consumer and/or of the supplier with the data supply chain and its components.

3. The method of claim 2, wherein additional governance values are based on the metrics comprising: defining and calculating statistics, wherein a statistic combines one or more metrics, or one or more scores, or one or more external factors, or any combination thereof, across any collection of one or more data supply chain components, using any function or formula; defining and calculating scores, wherein a score is a metric or a statistic, combined with a scaling factor, and combined with a weighting factor, across any collection of one or more data supply chain components, using any function or formula; and defining thresholds, wherein a threshold is set along the scale of a metric, a score, or a statistic.

4. The method of claim 1, wherein enforcing the contract comprises: enumerating an incentive for the supplier or the consumer; identifying the threshold which will trigger the incentive; invoking the incentive when the threshold is exceeded; and adjudicating, by the governing authority, any contractual dispute.

5. The method of claim 1, wherein improving the health of the data supply chain comprises: enumerating a health improvement action for the governing authority; identifying the threshold which will trigger the health improvement action; and invoking the health improvement action when the threshold is exceeded.

6. A system for data supply chain governance, comprising: a data model, wherein entities, and attributes of the entities, and relationships between the entities, are structured to contain the data necessary to support the process and the presentation models; a process model, wherein activities are performed to manipulate the data in the data model, and to present the data through, and receive input from, the presentation model; a presentation model, wherein the results of the process model activities are presented to a user, or to another system, and input from the user, or from another system, are presented to the process model; and a technical environment, wherein a collection of hardware, software, media, and/or other technical items is assembled to host the data model, the process model, and the presentation model.

7. The system of claim 6, wherein the data model entities represent a data supply chain governance method, comprising: reporting master data entities comprising supplier, consumer, object, purpose, contract, specification, and service; supporting master data entities comprising metric definition, score definition, statistic definition, threshold, weighting factor, scaling factor, incentive definition, action definition, operation maturity definition, implementation maturity definition, issue definition, and happiness definition; transaction data entities comprising collected metrics, collected issues, calculated scores, calculated statistics, incentive invocation history, action invocation history, and intermediate results required for process execution; and relations between the entities comprising purpose to object, object to object, consumer to object, object to service, object to specification, specification to service, supplier to service, contract to consumer, contract to supplier, contract to object, contract to service, contract to specification, service to metric, purpose to metric, metric to statistic, metric to score, score to statistic, scaling factor to score, weighting factor to score, metric to threshold, statistic to threshold, score to threshold, threshold to incentive, and threshold to action.

8. The system of claim 6, wherein the process model executes activities comprising: maintaining the master data; collecting the issues; collecting the metrics; calculating the scores and calculating the statistics; generating the presentations and managing the presentation dialogues; and managing the incentive and the action invocations.

9. The system of claim 8, wherein an activity of the process model may be initiated on a scheduled basis, an event driven basis, or an ad hoc basis, and may be triggered and executed by an automated mechanism, or a manual mechanism, or any combination thereof.

10. The system of claim 6, wherein the presentation model presents content and accepts input to facilitate the execution of a data supply chain governance method, comprising: presenting the metrics, the scores, and/or the statistics, with the option of highlights at the thresholds, with the option of summarization at any level of the reporting master data entity attributes; presenting alerts when the thresholds are exceeded; presenting the invocations of the incentives and the actions; presenting a map of the data supply chain, with the option to select the entities, the attributes, and the relations to present; and presenting user, or system, interaction interfaces for all activities in the process model for which user, or system, interaction is required.

11. The system of claim 10, wherein the presentation model delivers content, configurable to preferences of a user, or configurable to the technical requirements of another system, within the constraints of the technical environment capabilities.

12. The system of claim 10, wherein the presentation model content may be filtered by selectable parameters comprising: any collection of one or more of the reporting master data entity attributes; any timeframe, comprising: a current or an historical point in time, or an historical time period.

13. A method of implementing a new data supply chain governance environment, or of implementing a change to an existing data supply chain governance environment, in a manner that preserves the integrity and functionality of said environment and in a manner that preserves the ability to implement future changes to said environment, while fitting within the requirements of the implementation, by means of structured implementation tools designed to facilitate the implementation of a data supply chain governance environment, comprising: identifying the domain of the data supply chain governance environment; specifying the requirements for the data supply chain governance environment; employing said structured implementation tools; and implementing a new or changed data supply chain governance method, or implementing a new or changed data supply chain governance system in facilitation of the data supply chain governance method, or any combination thereof, in compliance with the requirements.
